(19) United States
(12) Patent Application Publication
(10) Pub. No.: US 2005/0096790 A1
(43) Pub. Date: May 5, 2005

(54) Robot apparatus for executing a monitoring operation

(76) Inventors: Masafumi Tamura, Chofu-shi (JP); Tomotaka Miyazaki, Kawasaki-shi (JP); Shunichi Kawabata, Ome-shi (JP); Takashi Yoshimi, Fujisawa-shi (JP); Junko Hirokawa, Tokyo (JP); Hideki Ogawa, Yokosuka-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/946,134

(22) Filed: Sep. 22, 2004

(30) Foreign Application Priority Data
Sep. 29, 2003 (JP) 2003-337757

(51) Int. Cl. G06F 19/00

(52) U.S. Cl. 700/245

(57) ABSTRACT

A robot apparatus executes a monitoring operation. The robot apparatus includes an operation mode switching unit that switches an operation of the robot apparatus between a first operation mode and a second operation mode, and a control unit that controls the operation of the robot apparatus, causes the robot apparatus to execute a first monitoring operation in the first operation mode, which is corresponded to a dynamic environment where a user is at home, and causes the robot apparatus to execute a second monitoring operation in the second operation mode, which is corresponded to a static environment where the user is not at home.

### CROSS-REFERENCE TO RELATED APPLICATIONS

This application is based upon and claims the benefit of priority from prior Japanese Patent Application No. 2003-337757, filed Sep. 29, 2003, the entire contents of which are incorporated herein by reference.

### BACKGROUND OF THE INVENTION

1. Field of the Invention

The present invention relates to a robot apparatus capable of executing a monitoring operation.

2. Description of the Related Art

In recent years, the introduction of home security systems has been promoted. The home security system is a system that monitors the conditions in a house by using various sensors such as surveillance cameras.

Jpn. Pat. Appln. KOKAI Publication No. 2001-245069 discloses a system that informs the user of occurrence of abnormality by calling the user's mobile phone. In this system, a home security box that can communicate with a mobile phone is used. The home security box is connected to a variety of sensors that are disposed within the house. If a sensor detects abnormality, the home security box calls the user's mobile phone and informs the user of the occurrence of abnormality.

In the above case, however, the sensors need to be disposed at various locations in the house, and this leads to a high cost for installation works.

Under the circumstances, attention has recently been paid to a system that executes a monitoring operation using a robot.

Jpn. Pat. Appln. KOKAI Publication No. 2003-51082 discloses a surveillance robot having an infrared sensor, an acoustic sensor, etc.

In the prior art, however, the content of a monitoring operation that is to be executed by the robot is fixedly determined. The robot executes the same monitoring operation at all times. Consequently, while the user is having a conversation with a guest or he/she is doing cooking, etc., the movement of the robot in the house may be unpleasant to the eye.

On the other hand, various sounds, odors, heat, etc. may be produced, for example, when the user cleans the house by means of a vacuum cleaner, or when the user does cooking by use of a kitchen stove. Besides, a person, such as a guest, other than the user may be present in the house. In such dynamic environments, it is likely that the robot may erroneously detect a change in environmental condition, which is caused by the user's action or the visit by a guest, as the occurrence of abnormality.

### BRIEF SUMMARY OF THE INVENTION

According to an embodiment of the present invention, there is provided a robot apparatus for executing a monitoring operation, comprising: an operation mode switching unit that switches an operation mode of the robot apparatus between a first operation mode and a second operation mode; and a control unit that controls the operation of the robot apparatus, causes the robot apparatus to execute a first monitoring operation in the first operation mode, which is corresponded to a dynamic environment where a user is at home, and causes the robot apparatus to execute a second monitoring operation in the second operation mode, which is corresponded to a static environment where the user is not at home.

According to another embodiment of the present invention, there is provided a robot apparatus for executing a monitoring operation, comprising: a main body including an auto-movement mechanism; a sensor that is provided on the main body and detects occurrence of abnormality in a house; an operation mode selection unit that selects one of an at-home mode corresponding to a case where a user is at home and a not-at-home mode corresponding to a case where the user is not at home; and a monitoring operation execution unit that executes, when the at-home mode is selected, a monitoring operation using the movement mechanism and the sensor at a first security level, and executes, when the not-at-home mode is selected, a monitoring operation using the movement mechanism and the sensor at a second security level that is higher than the first security level.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the external appearance of a robot apparatus according to an embodiment of the present invention;

FIG. 2 is a block diagram showing the system configuration of the robot apparatus shown in FIG. 1;

FIG. 3 is a view for explaining an example of a path of movement at a time the robot apparatus shown in FIG. 1 executes a patrol-monitoring operation;

FIG. 4 is a view for explaining an example of map information that is used in an auto-movement operation of the robot apparatus shown in FIG. 1;

FIG. 5 shows an example of authentication information that is used in an authentication process, which is executed by the robot apparatus shown in FIG. 1;

FIG. 6 shows an example of schedule management information that is used in a schedule management process, which is executed by the robot apparatus shown in FIG. 1;

FIG. 7 shows a plurality of operation modes of the robot apparatus shown in FIG. 1, and a transition between the modes;

FIG. 8 is a flow chart illustrating a monitoring operation that is executed by the robot apparatus shown in FIG. 1 in a “not-at-home mode” and a monitoring operation that is executed by the robot apparatus in an “at-home mode”;

FIG. 9 is a flow chart illustrating an example of a process procedure that is executed in the “not-at-home mode” by a system controller that is provided in the robot apparatus shown in FIG. 1;

FIG. 10 is a flow chart for explaining a “pretend-to-be-at-home” function, which is executed by the system controller that is provided in the robot apparatus shown in FIG. 1;

FIG. 11 is a flow chart illustrating an example of a process procedure in a “time-of-homecoming mode” that is executed by the system controller provided in the robot apparatus shown in FIG. 1;

FIG. 12 is a flow chart illustrating an example of a process procedure in the “at-home mode” that is executed by the system controller provided in the robot apparatus shown in FIG. 1; and

FIG. 13 is a flow chart illustrating an example of a process procedure in a “preparation-for-going-out mode” that is executed by the system controller provided in the robot apparatus shown in FIG. 1.

### DETAILED DESCRIPTION OF THE INVENTION

An embodiment of the present invention will now be described with reference to the accompanying drawings.

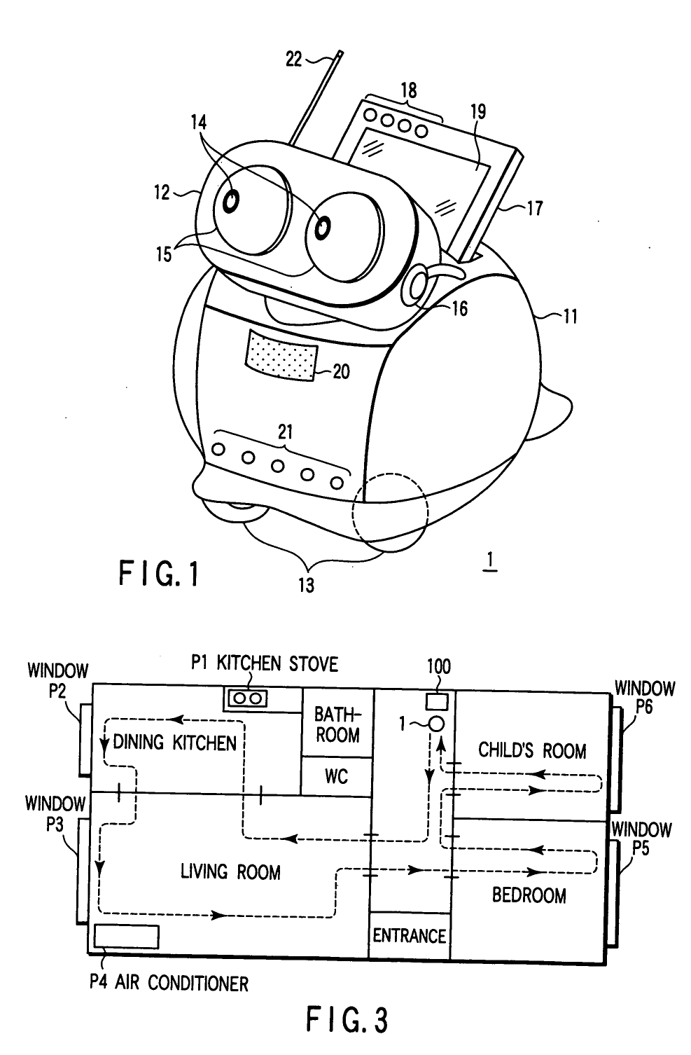

FIG. 1 shows the external appearance of a surveillance apparatus according to the embodiment of the invention. The surveillance apparatus executes a monitoring operation for security management in a house. The surveillance apparatus has an auto-movement mechanism and is realized as a robot apparatus 1 having a function for determining its own actions in order to support users.

The robot apparatus 1 includes a substantially spherical robot body 11 and a head unit 12 that is attached to a top portion of the robot body 11. The head unit 12 is provided with two camera units 14. Each camera unit 14 is a device functioning as a visual sensor. For example, the camera unit 14 comprises a CCD (Charge-Coupled Device) camera with a zoom function. Each camera unit 14 is attached to the head unit 12 via a spherical support member 15 such that a lens unit serving as a visual point is freely movable in vertical and horizontal directions. The camera units 14 take in images such as images of the faces of persons and images of the surroundings. The robot apparatus 1 has an authentication function for identifying a person by using the image of the face of the person, which is imaged by the camera units 14.

The head unit 12 further includes a microphone 16 and an antenna 22. The microphone 16 is a voice input device and functions as an audio sensor for sensing the user's voice and the sound of surroundings. The antenna 22 is used to execute wireless communication with an external device.

The bottom of the robot body 11 is provided with two wheels 13 that are freely rotatable. The wheels 13 constitute a movement mechanism for moving the robot body 11. Using the movement mechanism, the robot apparatus 1 can autonomously move within the house.

A display unit 17 is mounted on the back of the robot body 11. Operation buttons 18 and an LCD (Liquid Crystal Display) 19 are mounted on the top surface of the display unit 17. The operation buttons 18 are input devices for inputting various data to the robot body 11. The operation buttons 18 are used to input, for example, data for designating the operation mode of the robot apparatus 11 and a user's schedule data. The LCD 19 is a display device for presenting various information to the user. The LCD 19 is realized, for instance, as a touch screen device that can recognize a position that is designated by a stylus (pen) or the finger.

The front part of the robot body 11 is provided with a speaker 20 functioning as a voice output device, and sensors 21. The sensors 21 include a plurality of kinds of sensors for detecting abnormality in the house, for instance, a temperature sensor, an odor sensor, a smoke sensor, and a door/window open/close sensor. Further, the sensors 21 include an obstacle sensor for assisting the auto-movement operation of the robot apparatus 1. The obstacle sensor comprises, for instance, a sonar sensor.

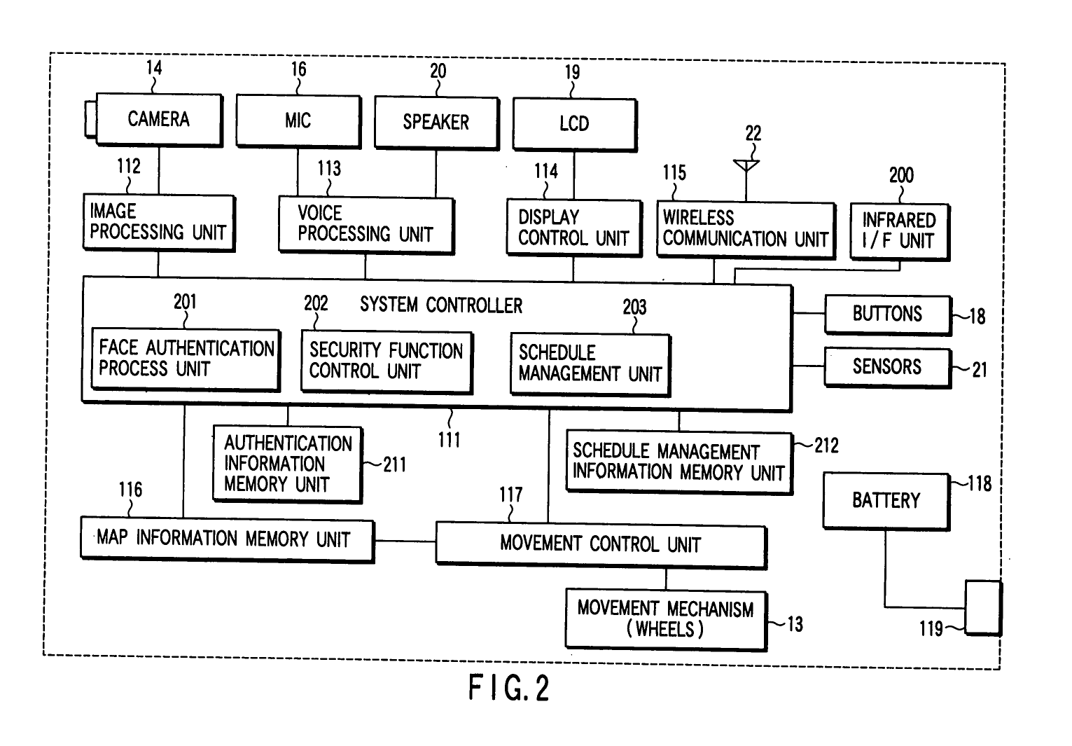

Next, the system configuration of the robot apparatus 1 is described referring to FIG. 2.

The robot apparatus 1 includes a system controller 111, an image processing unit 112, a voice processing unit 113, a display control unit 114, a wireless communication unit 115, a map information memory unit 116, a movement control unit 117, a battery 118, a charge terminal 119, and an infrared interface unit 200.

The system controller 111 is a processor for controlling the respective components of the robot apparatus 1. The system controller 111 controls the actions of the robot apparatus 1. The image processing unit 112 processes, under control of the system controller 111, images that are taken by the camera 14. Thereby, the image processing unit 112 executes, for instance, a face detection process that detects and extracts a face image area corresponding to the face of person, from image that are taken by the camera 14. In addition, the image processing unit 112 executes a process for extracting features of the surrounding environment, on the basis of images that are taken by the camera 14, thereby to produce map information within the house, which is necessary for auto-movement of the robot apparatus 1.

The voice processing unit 113 executes, under control of the system controller 111, a voice (speech) recognition process for recognizing a voice (speech) signal that is input from the microphone (MIC) 16, and a voice (speech) synthesis process for producing a voice (speech) signal that is to be output from the speaker 20. The display control unit 114 is a graphics controller for controlling the LCD 19.

The wireless communication unit 115 executes wireless communication with the outside via the antenna 22. The wireless communication unit 115 comprises a wireless communication module such as a mobile phone or a wireless modem. The wireless communication unit 115 can execute transmission/reception of voice and data with an external terminal such as a mobile phone. The wireless communication unit 115 is used, for example, in order to inform the mobile phone of the user, who is out of the house, of occurrence of abnormality within the house, or in order to send video, which shows conditions of respective locations within the house, to the user's mobile phone.

The map information memory unit 116 is a memory unit that stores map information, which is used for auto-movement of the robot apparatus 1 within the house. The map information is map data relating to the inside of the house. The map information is used as path information that enables the robot apparatus 1 to autonomously move to a plurality of predetermined check points within the house. As is shown in FIG. 3, the user can designate given locations within the house as check points P1 to P6 that require monitoring. The map information can be generated by the robot apparatus 1.

Now let us consider a case where the robot apparatus 1 generates map information that is necessary for patrolling the check points P1 to P6. For example, the user guides the robot apparatus 1 from a starting point to a destination point by a manual operation or a remote operation using an infrared remote-control unit. While the robot apparatus 1 is being guided, the system controller 111 observes and recognizes the surrounding environment using video acquired by the camera 14. Thus, the system controller 111 automatically generates map information on a route from the starting point to the destination point. Examples of the map information include coordinates information indicative of the distance of movement and the direction of movement, and environmental map information that is a series of characteristic images indicative of characteristics of the surrounding environment.

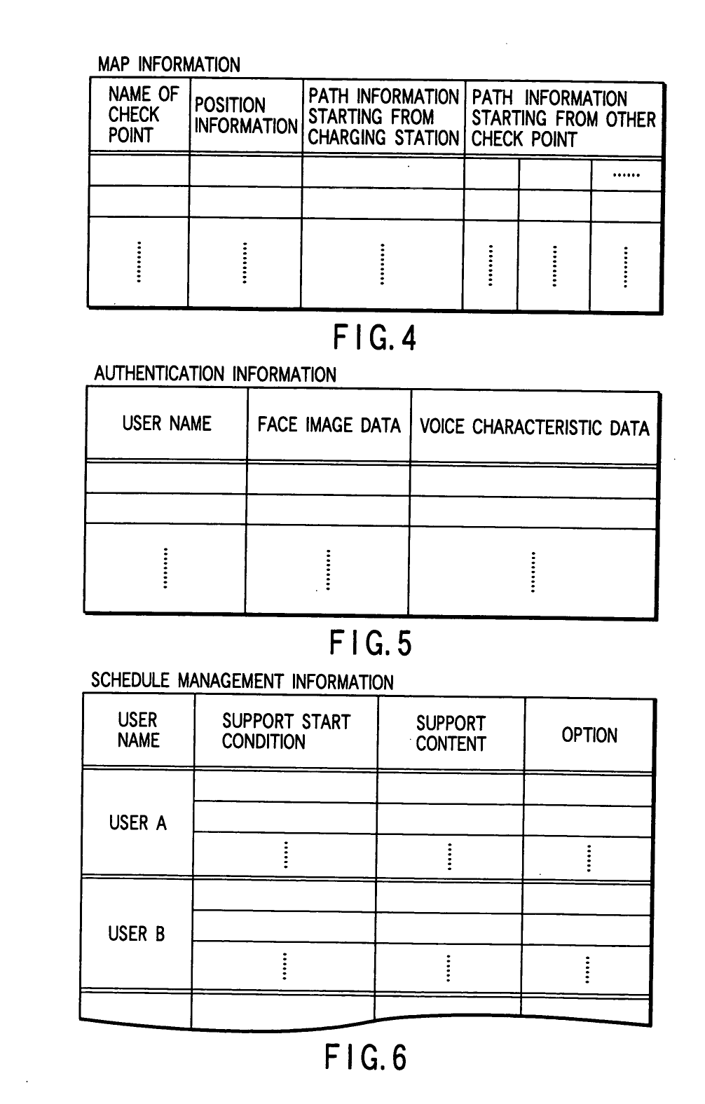

In the above case, the user guides the robot apparatus 1 by manual or remote control in the order of check points P1 to P6, with the start point set at the location of a charging station 100 for battery-charging the robot apparatus 1. Each time the robot apparatus 1 arrives at a check point, the user notifies the robot apparatus 1 of the presence of the check point by operating the buttons 18 or by a remote-control operation. Thus, the robot apparatus 1 is enabled to learn the path of movement (indicated by a broken line) and the locations of check points along the path of movement. It is also possible to make the robot apparatus 1 learn each of individual paths up to the respective check points P1 to P6 from the start point where the charging station 100 is located. While the robot apparatus 1 is being guided, the system controller 111 of robot apparatus 1 successively records, as map information, characteristic images of the surrounding environment that are input from the camera 14, the distance of movement, and the direction of movement. FIG. 4 shows an example of the map information.

The map information in FIG. 4 indicates [NAME OF CHECK POINT], [POSITION INFORMATION], [PATH INFORMATION STARTING FROM CHARGING STATION] and [PATH INFORMATION STARTING FROM OTHER CHECK POINT] with respect to each of check points designated by the user. The [NAME OF CHECK POINT] is a name for identifying the associated check point, and it is input by the user's operation of buttons 18 or the user's voice input operation. The user can freely designate the names of check points. For example, the [NAME OF CHECK POINT] of check point P1 is “kitchen stove of dining kitchen”, and the [NAME OF CHECK POINT] of check point P2 is “window of dining kitchen.”

The [POSITION INFORMATION] is information indicative of the location of the associated check point. This information comprises coordinates information indicative of the location of the associated check point, or a characteristic image that is acquired by imaging the associated check point. The coordinates information is expressed by two-dimensional coordinates (X, Y) having the origin at, e.g. the position of the charging station 100. The [POSITION INFORMATION] is generated by the system controller 111 while the robot apparatus 1 is being guided.

The [PATH INFORMATION STARTING FROM CHARGING STATION] is information indicative of a path from the location, where the charging station 100 is placed, to the associated check point. For example, this information comprises coordinates information that indicates the length of an X-directional component and the length of a Y-directional component with respect to each of straight line segments along the path, or environmental map information from the location, where the charging station 100 is disposed, to the associated check point. The [PATH INFORMATION STARTING FROM CHARGING STATION] is also generated by the system controller 111.

The [PATH INFORMATION STARTING FROM OTHER CHECK POINT) is information indicative of a path to the associated check point from some other check point. For example, this information comprises coordinates information that indicates the length of an X-directional component and the length of a Y-directional component with respect to each of straight line segments along the path, or environmental map information from the location of the other check point to the associated check point. The [PATH INFORMATION STARTING FROM OTHER CHECK POINT] is also generated by the system controller 111.

The movement control unit 117 shown in FIG. 2 executes, under control of the system controller 111, a movement control process for autonomous movement of the robot body 11 to a target position according to the map information. The movement control unit 117 includes a motor that drives the two wheels 13 of the movement mechanism, and a controller for controlling the motor.

The battery 13 is a power supply for supplying operation power to the respective components of the robot apparatus 1. The charging of the battery 13 is automatically executed by electrically connecting the charging terminal 119, which is provided on the robot body 11, to the charging station 100. The charging station 100 is used as a home position of the robot apparatus 1. At an idling time, the robot apparatus 1 autonomously moves to the home position. If the robot apparatus 1 moves to the charging station 100, the charging of the battery 13 automatically starts.

The infrared interface unit 200 is used, for example, to remote-control the turn on/off of devices, such as an air conditioner, a kitchen stove and lighting equipment, by means of infrared signals, or to receive infrared signals from the external remote-control unit.

The system controller 111, as shown in FIG. 2, includes a face authentication process unit 201, a security function control unit 202 and a schedule management unit 203. The face authentication process unit 201 cooperates with the image processing unit 112 to analyze a person's face image that is taken by the camera 14, thereby executing an authentication process for identifying the person who is imaged by the camera 14.

In the authentication process, face images of users (family members), which are prestored in the authentication information memory unit 211 as authentication information, are used. The face authentication process unit 201 compares the face image of the person imaged by the camera 14 with each of the face images stored in the authentication information memory unit 211. Thereby, the face authentication process unit 201 can determine which of the users corresponds to the person imaged by the camera 14, or whether the person imaged by the camera 14 is a family member or not. FIG. 5 shows an example of authentication information that is stored in the authentication information memory unit 211. As is shown in FIG. 5, the authentication information includes, with respect to each of the users, the user name, the user face image data and the user voice characteristic data. The voice characteristic data is used as information for assisting user authentication. Using the voice characteristic data, the system controller 111 can determine which of the users corresponds to the person who utters voice, or whether the person who utters voice is a family member or not.

The security function control unit 202 controls the various sensors (sensors 21, camera 14, microphone 16) and the movement mechanism 13, thereby executing a monitoring operation for detecting occurrence of abnormality within the house (e.g. entrance of a suspicious person, fire, failure to turn out the kitchen stove, leak of gas, failure to turn off the air conditioner, failure to close the window, and abnormal sound). In other words, the security function control unit 202 is a control unit for controlling the monitoring operation (security management operation) for security management, which is executed by the robot apparatus 1.

The security function control unit 202 has a plurality of operation modes for controlling the monitoring operation that is executed by the robot apparatus 1. Specifically, the operation modes include an “at-home mode” and a “not-at-home mode.”

The “at-home mode” is an operation mode that is suited to a dynamic environment in which a user is at home. The “not-at-home mode” is an operation mode that is suited to a static environment in which users are absent. The security function control unit 202 controls the operation of the robot apparatus 1 so that the robot apparatus 1 may execute different monitoring operations between the case where the operation mode of the robot apparatus 1 is set in the “at-home mode” and the case where the operation mode of the robot apparatus 1 is set in the “not-at-home mode.”

The alarm level (also known as “security level”) of the monitoring operation, which is executed in the “not-at-home mode”, is higher than that of the monitoring operation, which is executed in the “at-home mode.”

For example, in the “not-at-home mode,” if the face authentication process unit 201 detects that a person other than the family members is present within the house, the security function control unit 202 determines that a suspicious person has entered the house, and causes the robot apparatus 1 to immediately execute an alarm process. In the alarm process, the robot apparatus 1 executes a process of sending, by e-mail, etc., a message indicative of the entrance of the suspicious person to the user's mobile phone, a security company, etc. On the other hand, in the “at-home mode”, the execution of the alarm process is prohibited. Thereby, even if the face authentication process unit 201 detects that a person other than the family members is present within the house, the security function control unit 202 only records an image of the face of the person and does not execute the alarm process. The reason is that in the “at-home mode” there is a case where a guest is present in the house.

Besides, in the “not-at-home mode”, if the sensors detect abnormal sound, abnormal heat, etc., the security function control unit 202 immediately executes the alarm process. In the “at-home mode”, even if the sensors detect abnormal sound, abnormal heat, etc., the security function control unit 202 does not execute the alarm process, because some sound or heat may be produced by actions in the user's everyday life. Instead, the security function control unit 202 executes only a process of informing the user of the occurrence of abnormality by issuing a voice message such as “abnormal sound is sensed” or “abnormal heat is sensed.”

Furthermore, in the “not-at-home mode”, the security function control unit 202 cooperates with the movement control unit 117 to control the auto-movement operation of the robot apparatus 1 so that the robot apparatus 1 may execute an auto-monitoring operation. In the auto-monitoring operation, the robot apparatus 1 periodically patrols the check points P1 to P5. In the “at-home mode”, the robot apparatus 1 does not execute the auto-monitoring operation that involves periodic patrolling.

The security function control unit 202 has a function for switching the operation mode between the “at-home mode” and “not-at-home mode” in accordance with the user's operation of the operation buttons 21. In addition, the security function control unit 202 may cooperate with the voice processing unit 113 to recognize, e.g. a voice message, such as “I'm on my way” or “I'm back”, which is input by the user. In accordance with the voice input from the user, the security function control unit 202 may automatically switch the operation mode between the “at-home mode” and “not-at-home mode.”

Not-at-Home Mode

A description is given of an example of the monitoring operation that is executed by the robot apparatus in the “not-at-home mode.”

In the “not-at-home mode”, the robot apparatus 1 executes a function of monitoring the conditions in the house while the user is out of the house. For instance, the robot apparatus 1 may execute an auto-monitoring function, a remote-monitoring function, and a “pretend-to-be-at-home” function. The auto-monitoring function is a function for informing the user, who is out of the house, or a predetermined destination, of occurrence of abnormality, if such abnormality is detected. The remote-monitoring function is a function for informing, upon instruction from the user who is out of the house, the user of conditions in the house by images or voice, or for sending a record of monitored conditions to the user who is out. The pretend-to-be-at-home function is a function for making such a disguise that a person (stranger) outside the house may not notice that the user is “not at home” while the user is out of the house.

Auto-Monitoring Function

(1) Surveillance for Abnormality and Recording of it in House While User is Out:

# The robot apparatus 1 periodically patrols the inside of the house and monitors the conditions in the house while the user is out, and records sounds and images indicative of the conditions as surveillance record information. The robot apparatus 1 accumulates and keeps, at all times, data corresponding to a predetermined time period. When occurrence of abnormality is detected, data associated with conditions before and after the occurrence of abnormality is recorded along with the associated time and the location of the robot apparatus 1 at that time.

# The robot apparatus 1 monitors and records sound. If pre-registered recognizable sound is detected, the robot apparatus 1 records the sound. The sound to be detected is relatively large sound that comes from the outside of the house (e.g. sound of opening/closing of a door, sound of breakage of glass, sound of explosion, abnormal sound at a time of entrance of a suspicious person or at a time of abnormal weather, ringing of a doorbell, or phone call sound).

# The robot apparatus 1 records images. The robot apparatus periodically patrols the inside of the house, and automatically records images of individual check points.

(2) Alarm

# The robot apparatus 1 makes a call to the user's mobile phone who is out of the house, and informs him/her of the occurrence of abnormality by means of, e.g. e-mail.

(3) On-Site Action

# If the robot apparatus 1 detects occurrence of abnormality such as entrance of a suspicious person, it executes an on-site action such as production of a warning (words), production of an alarm (alarm sound, large sound), or emission of flash light (threatening, imaging).

Remote-Monitoring Function

(1) Checking of Conditions in the House from Outside:

# The robot apparatus 1 moves to a check point according to an instruction from the user who is out, and directs the camera 14 toward the check point. Video data that is acquired by the camera 14 is sent to the user who is out.

(2) Checking of Monitoring Record Data from Outside

# Upon receiving an instruction from the use who is out, the robot apparatus 1 sends monitoring record data, which is acquired by automatic monitoring, to the user.

Pretend-to-be-at-Home Function

# The robot apparatus 1 repeats a process for periodically activating and deactivating illumination equipment, a TV, audio equipment, an air conditioner, an electric fan, etc. The automatic activation/deactivation can be executed using infrared signals.

# The robot apparatus 1 periodically produces light (illumination), sound (daily-life sound), and wind (movement of curtain, etc.).

At-Home Mode

An example of the monitoring operation that is executed by the robot apparatus 1 in the “at-home mode” is described below.

In the “at-home mode”, the robot apparatus 1 execute, on behalf of the user, a function for dealing with abnormality that occurs while the user is at home. Specifically, the robot apparatus 1 executes the following functions.

# The robot apparatus 1 monitors and records sound (i.e. recording abnormal sound (entrance of a suspicious person, sound of opening/closing of a door, sound of breakage of glass, sound of explosion, abnormal weather), ringing of a doorbell, or phone call sound).

# The robot apparatus 1 records images (i.e. automatically recording images indicative of surrounding conditions at a time of detection of abnormal sound or at regular time intervals).

# If abnormality is detected, the robot apparatus 1 approaches the user and informs the user of the occurrence of abnormality with voice.

Next, the schedule management unit 203 of the system controller 111 is described. The schedule management unit 203 manages the schedules of a plurality of users (family members) and thus executes a schedule management process for supporting the actions of each user. The schedule management process is carried out according to schedule management information that is stored in a schedule management information memory unit 212. The schedule management information is information for individually managing the schedule of each of the users. In the stored schedule management information, user identification information is associated with an action that is to be done by the user who is designated by the user identification information and with the condition for start of the action.

The schedule management information, as shown in FIG. 6, includes a [USER NAME] field, a [SUPPORT START CONDITION] field, a [SUPPORT CONTENT] field and an [OPTION] field. The [USER NAME] field is a field for storing the name of the user as user identification information.

The [SUPPORT START CONDITION] field is a field for storing information indicative of the condition on which the user designated by the user name stored in the [USER NAME] field should start the action. For example, the [SUPPORT START CONDITION] field stores, as a start condition, a time (date, day of week, hour, minute) at which the user should start the action, or the content of an event (e.g. “the user has had a meal,” or “it rains”) that triggers the start of the user's action. Upon arrival of the time set in the [SUPPORT START CONDITION] field or in response to the occurrence of an event set in the [SUPPORT START CONDITION] field, the schedule management unit 203 controls the operation of the robot apparatus 1 so that the robot apparatus 1 may start a supporting action that supports the user's action.

The [SUPPORT CONTENT] field is a field for storing information indicative of the action that is to be done by the user. For instance, the [SUPPORT CONTENT] field stores the user's action such as “going out”, “getting up”, “taking a drug”, or “taking the washing in.” The schedule management unit 203 controls the operation of the robot apparatus 1 so that the robot apparatus 1 may execute a supporting action that corresponds to the content of user's action set in the [SUPPORT CONTENT] field. Examples of the supporting actions that are executed by the robot apparatus 1 are: “to prompt going out”, “to read with voice the check items (closing of windows/doors, turn-out of gas, turn-off of electricity) for safety confirmation at the time of going out”, “to read with voice the items to be carried at the time of going out”, “to prompt getting up”, “to prompt taking a drug”, and “to prompt taking the washing in.” The [OPTION] field is a field for storing, for instance, information on a list of check items for safety confirmation as information for assisting a supporting action.

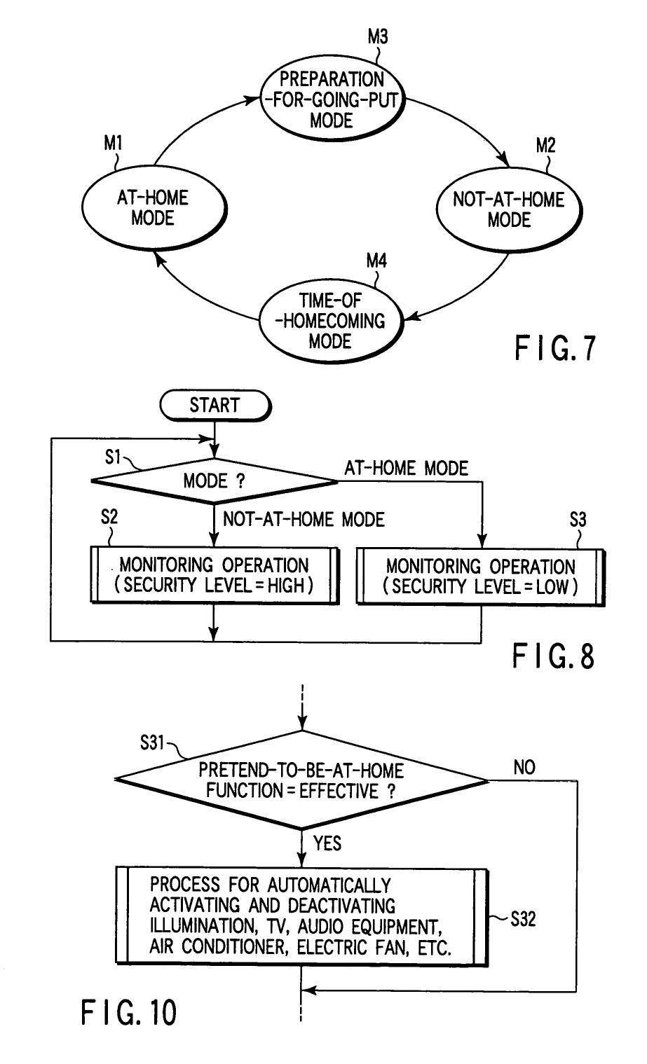

FIG. 7 shows a transition between operation modes of the robot apparatus shown in FIG. 1. As mentioned above, the robot apparatus 1 has an “at-home mode” M1 and a “not-at-home mode” M2 as operation modes for executing the monitoring operation for security management. As is illustrated in a flow chart of FIG. 8, the system controller 111 determines whether the current operation mode of the robot apparatus 1 is the “at-home mode” or the “not-at-home mode” (step S1).

In the “not-at-home mode”, the system controller 111 controls the operation of the robot apparatus 1 so that the robot apparatus 1 may execute a monitoring operation (with a high security level) that is predetermined in accordance with a static environment in which the user is absent (step S2). On the other hand, in the “at-home mode”, the system controller 111 controls the operation of the robot apparatus 1 so that the robot apparatus 1 may execute a monitoring operation (with a low security level) that is predetermined in accordance with a dynamic environment in which the user is present (step S3).

The robot apparatus 1 further includes a “preparation-for-going-out mode” M3 and a “time-of-homecoming mode” M4, as illustrated in FIG. 7. The “preparation-for-going-out mode” is an operation mode for executing a function for supporting the user's preparation for going out. In the “preparation-for-going-out mode”, the system controller 111 controls the operation of the robot apparatus 1 so that the robot apparatus 1 may execute an operation for informing the user of the check items for safety confirmation before the user goes out. The function for supporting the user's preparation for going out is executed in cooperation with the schedule management function.

Specifically, when the time for going out, which is preset as schedule management information, draws near, the robot apparatus 1 informs the user of it and automatically transits from the “at-home mode” to the “preparation-for-going-out mode.” Alternatively, when the user says “I'll go”, the robot apparatus 1 automatically transits from the “at-home mode” to the “preparation-for-going-out mode.” If the user says “I'm on my way”, the robot apparatus 1 automatically transits from the “preparation-for-going-out mode” to the “not-at-home mode.” The “time-of-homecoming mode” is a function for meeting the user who is coming home and preventing a suspicious person from coming in when the user opens the door.

The robot apparatus 1, as described above, has the operation mode “at-home mode” that corresponds to the environment in which the user is at home; the operation mode “not-at-home mode” that corresponds to the environment in which the user is not at home; the operation mode “preparation-for-going-out mode” that corresponds to the environment at a time just before the user goes out; and the operation mode “time-of-homecoming mode” that corresponds to the environment at a time when the user comes home. The robot apparatus 1 executes different security management operations in the respective modes. Therefore, the robot apparatus 1 can execute operations (monitoring operations) for security management, which are suited to various environments in which the user is at home, the user is not at home, the user is about to go out, and the user comes home.

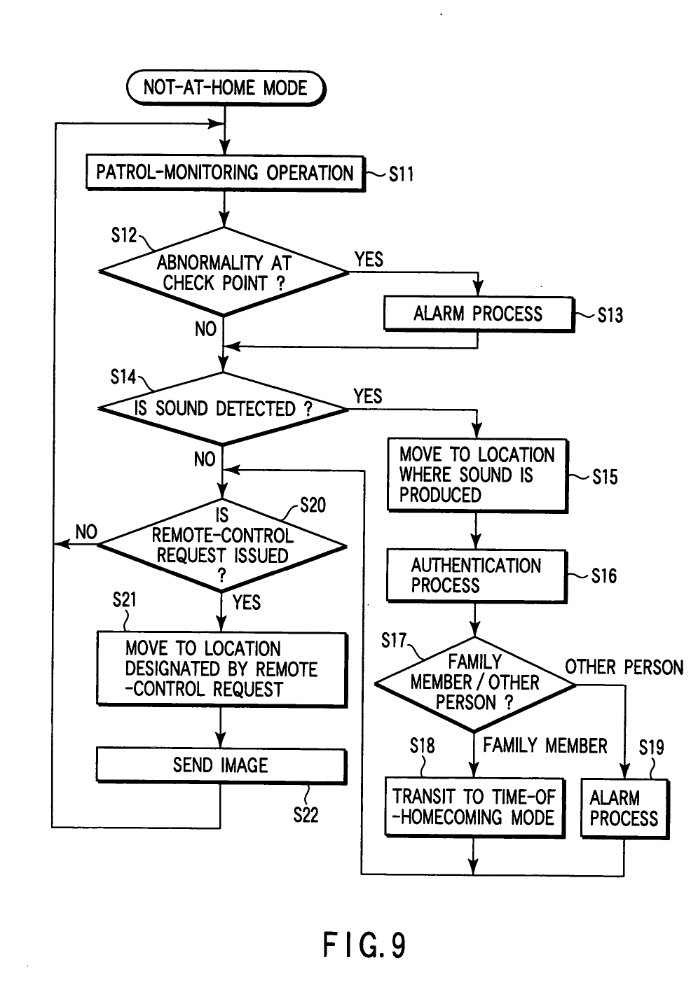

Referring now to a flow chart of FIG. 9, a description is given of an example of the process procedure that is executed by the system controller 111 in the “not-at-home mode.”

The system controller 111 controls the operation of the robot apparatus 1 so that the robot apparatus 1 may execute a monitoring process while patrolling the inside of the house (step S11). In this patrol-monitoring process, the robot apparatus 1 autonomously moves within the house according to map information in the order from point P1 to point P6 and checks whether abnormality occurs at the respective check points. For example, if the robot apparatus 1 detects at a certain check point the occurrence of abnormality such as leak of gas, production of heat, production of smoke, or opening of a window, the system controller 111 records video images and sound at the check point and executes an alarm process for sending a message indicative of the occurrence of abnormality to the user's mobile phone via the wireless communication unit 22 (step S13). In step S13, the system controller 111, for example, creates an e-mail including a message indicative of the occurrence of abnormality and sends the e-mail to the user's mobile phone or a security company.

If sound (e.g. sound of opening/closing of a door, sound of opening/closing of a window) is detected, the system controller 111 executes a process for approaching the robot body 11 to the vicinity of the location where such sound is produced (step S15). Then, in order to check whether entrance of a suspicious person occurs or not, the system controller 111 executes an authentication process for identifying the person that is imaged by the camera 14 (step S16). The system controller 111 executes the above-mentioned face authentication process, thereby determining whether the person imaged by the camera 14 is the user (family member) or a person other than the family members (step S17).

If the person imaged by the camera 14 is the user, the system controller 111 determines that the user comes home, and switches the operation mode of the robot apparatus 1 from the “not-at-home mode” to the “time-of-homecoming mode” (step S18). On the other hand, if the person imaged by the camera 14 is not the user and is some other person, the system controller 111 records the face image of the person imaged by the camera 14 and executes the alarm process (step S19). In step S19, the system controller 111 produces threat sound and sends an e-mail to the mobile phone of the user who is out, or to a security company.

In the monitoring process, if a remote-control command (remote-control request) that is sent from the user's mobile phone is received by the wireless communication unit 22 (YES in step S20), the system controller 111 executes a process to move the robot body 11 to a to-be-monitored location (e.g. one of check points) in the house, which is designated by the received remote-control command (step S21). The system controller 111 causes the camera 14 to image the location designated by the remote-control command and sends the image (still image or motion video) to the user's mobile phone via the wireless communication unit 22 (step S22).

A description is given of how the user designates the to-be-monitored location from a location where the user goes out. As mentioned above, the map information includes the check point names corresponding to a plurality of check points. Responding to the remote-control request that is sent from the user's mobile phone, the system controller 111 generates information (e.g. an HTML (Hyper Text Markup Language) document) indicative of a list of check point names, and sends the generated information to the user's mobile phone. The list of check point names is displayed on the screen of the user's mobile phone. Since the check point names are designated by the user, the list of check point names, such as “kitchen stove in the dining kitchen” or “air conditioner in the living room”, can be displayed on the screen of the mobile phone in an easy-to-understand format. If the user designates a check point name by a button operation through the mobile phone, the information for designating the check point name is sent from the mobile phone to the robot apparatus 1. The system controller 111 determines the destination of movement of the robot apparatus 1 in accordance with the information indicative of the check point name, which is sent from the mobile phone. The movement process is executed using map information that corresponds to the designated check point name.

Next, referring to a flow chart in FIG. 10, a description is given of the “pretend-to-be-at-home function” that is executed in the “not-at-home mode” by the system controller 111. The pretend-to-be-at-home function is an optional function that is executed on an as-needed basis. The user can predetermine whether the pretend-to-be-at-home function is to be executed in the “not-at-home mode.”

The system controller 111 determines whether the pretend-to-be-at-home function is effective, that is, whether the user pre-designates the execution of the pretend-to-be-at-home function in the “not-at-home mode” (step S31). If the pretend-to-be-at-home function is effective (YES in step S31), the system controller 111 executes a process for automatically activating and deactivating the illumination equipment, TV, audio equipment, air conditioner, electric fan, etc., by a remote-control operation using the infrared interface unit 200 (step S32). As regard the illumination, for example, lamps are turned on in the evening, turned off at midnight, and turned on for a predetermined time period in the morning.

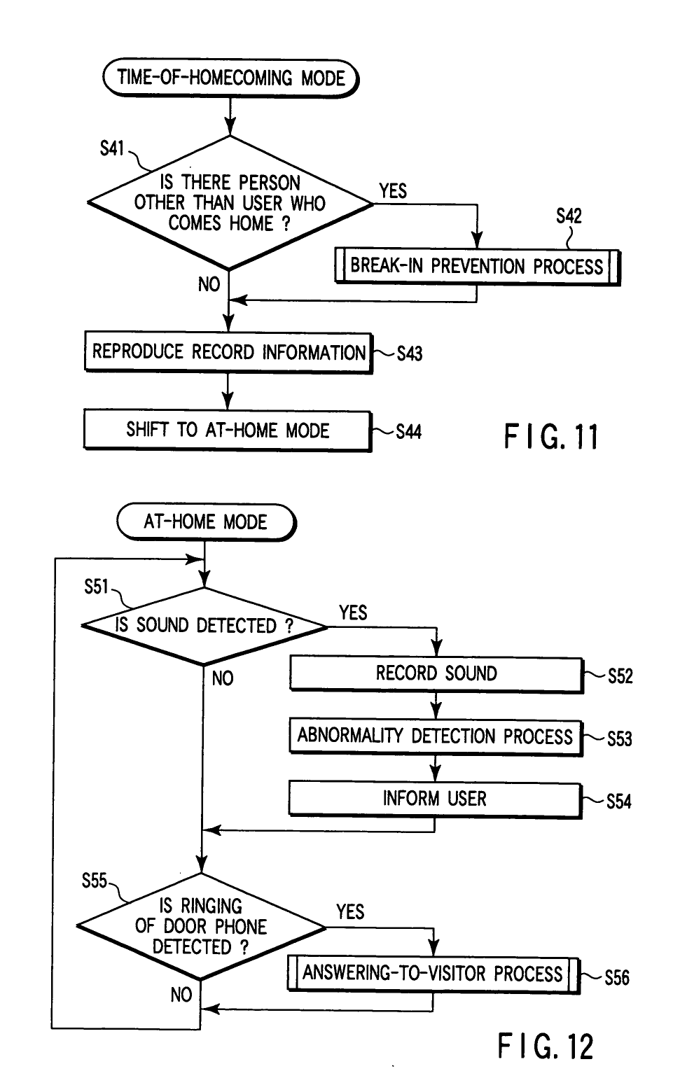

Next, referring to a flow chart in FIG. 11, a description is given of an example of the process procedure that is executed in the “time-of-homecoming mode” by the system controller 111.

After confirming that the person who has opened the door at the entrance is the user, the system controller 111 determines whether a person other than the user is present, for example, behind the user, on the basis of video acquired by the camera 14 or video acquired by a surveillance camera installed at the entrance (step S41). If there is such a person (YES in step S41), the system controller 111 executes a break-in prevention process (step S42). In step S42, the system controller 111 executes such a process as to continue monitoring the entrance by means of the camera 14. If break-in by a person is detected, the system controller 111 informs the user of it by producing an alarm sound, or issues an alarm to a pre-registered phone number or mail address.

If there is no person other than the user (NO in step S41), the system controller 111 reproduces, upon an instruction for reproduction by the user, the sound and images, which are recorded as monitoring record information in the “not-at-home mode”, through the speaker 20 and LCD 19, respectively. Then, the system controller 111 switches the operation mode of the robot apparatus 1 to the “at-home mode” (steps S43 and S44).

It is also possible to send information, which indicates that the user who is out is about to come home, to the robot apparatus 1 from the mobile phone, thereby making the robot apparatus wait at the entrance.

Referring now to a flow chart of FIG. 12, a description is given of an example of the process procedure that is executed by the system controller 111 in the “at-home mode.”

In the “at-home mode”, the system controller 111 monitors sound and records the sound. If a relatively large sound (e.g. opening/closing of the door, opening/closing of the window) is detected (YES in step S51), the system controller 111 records the sound as monitoring record information (step S52). The system controller 111 then executes a process for moving the robot body 11 to the vicinity of the location where the sound is produced, and executes an abnormality detection process using the camera 14 and various sensors 21 (step S53). In step S53, the system controller 111 executes a process of recording video data of surrounding conditions, which is acquired by the camera 14 as monitoring record information. The system controller 111 also executes a process of detecting abnormal heat, presence/absence of smoke, etc. The detection result is also recorded as monitoring record information. If abnormal heat, production of smoke, etc. is detected, the system controller 111 informs the user of the occurrence of abnormality by issuing a voice message such as “abnormal heat is sensed” or “smoke is sensed” (step S54). An alarm to the outside, for example, to a security company, is executed in accordance with the user's instruction.

The system controller 111 can execute an “answering-to-visitor” process in cooperation with, e.g. a camera and a microphone-equipped door phone, via a home network such as a wireless LAN, etc. In the answering-to-visitor process, the robot apparatus 1, on behalf of the user, answers a visitor while the user is at home, in particular, a door-to-door salesman. If ringing of the door phone is detected, the system controller 111 executes the answering-to-visitor process (step S56). In the answering-to-visitor process, for example, the following procedure is executed.

The system controller 111 cooperates with the door phone and asks about the business of the visitor with voice. In this case, a message “Please face this direction” is issued, and a face authentication process is executed. If the visitor fails to face this direction, the system controller 111 determines that the visitor is a door-to-door salesman. The system controller 111 records voice and video information that is acquired through the door phone.

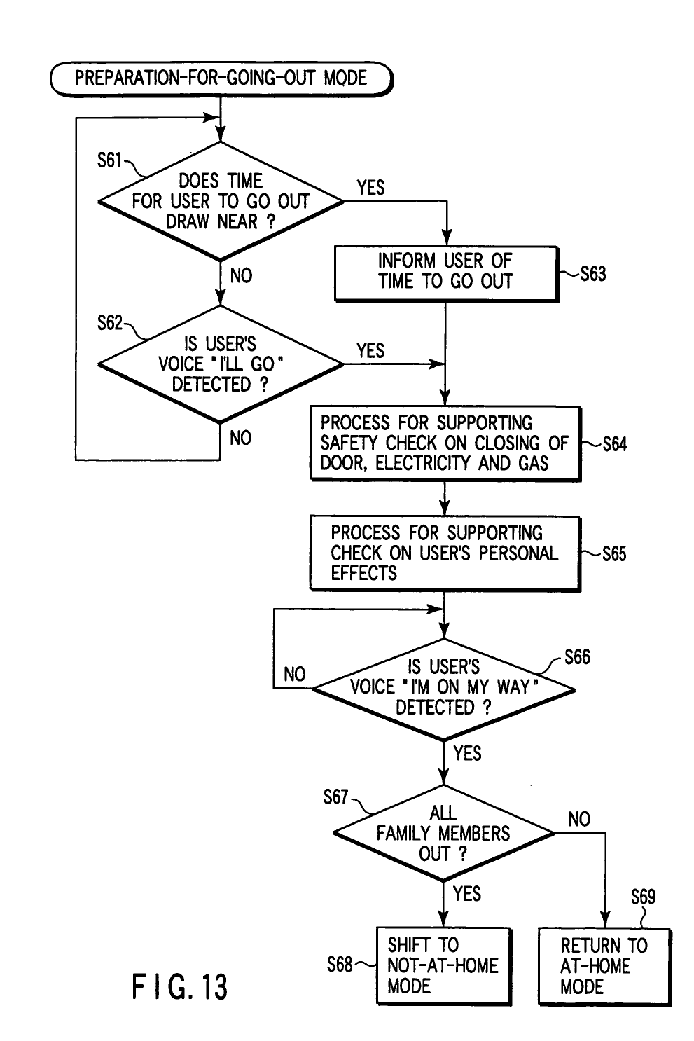

Next, referring to a flow chart of FIG. 13, a description is given of an example of the process procedure of a preparation-for-going-out supporting function that is executed by the system controller 111 in the “preparation-for-going-out mode.”

When the time for going out, which is preset as schedule management information, draws near (YES in step S61), or when the user's voice “I'll go” is detected (YES in step S62), the system controller 111 starts the preparation-for-going-out supporting function. If the time for going out, which is preset as schedule management information, draws near (YES in step S61), the system controller 111 informs, before starting the preparation-for-going-out supporting function, the user, for whom the schedule management information is registered, of the coming of the time for going-out (step S63). In this case, the system controller 111 acquires the user name “XXXXXX” from the schedule management information, and executes a process for producing a voice message, such as “Mr./Ms. XXXXXX, it's about time to go out”, from the speaker 20. In addition, it is possible to identify the user by a face recognition process, approach the user, and produce a voice message, such as “It's about time to go out.”

In the preparation-for-going-out supporting process, the system controller 111 first executes a process for informing the user with a voice message of the check items (closing of door, electricity, gas, etc.) for safety confirmation on an item-by-item basis (step S64). The check items for safety confirmation may be pre-registered in, e.g. the (OPTION] field of the schedule management information. The user informs the robot apparatus 1 with voice about the completion of checking of each item.

Next, the system controller 111 executes a process for informing the user by a voice message about the items of his/her indispensable personal effects (mobile phone, key of door, etc.) on an item-by-item basis (step S65). The items of indispensable personal effects may be pre-registered in, e.g. the [OPTION] field of the schedule management information.

If the user's voice “I'm on my way” is detected (step S66), the system controller 111 recognizes that the user, who said “I'm on my way”, has gone out. Then, the system controller 111 determines whether all family members including the user, who said “I'm on my way”, have gone out (step S67). This determination can be effected using a going-out list for managing whether each of the family members is away from home. Each time one user goes out, the system controller 111 sets a going-out flag in the going-out list, which indicates that this user is out. In addition, each time one user comes home, the system controller 111 resets the going-out flag associated with this user.

If all family members have gone out (YES in step S67), the system controller 111 shifts the operation mode of the robot apparatus 1 from the “preparation-for-going-out mode” to the “not-at-home mode” (step S68). On the other hand, if at least one family member is at home (NO in step S67), the system controller 111 restores the operation mode of the robot apparatus 1 from the “preparation-for-going-out mode” to the “at-home mode” (step S69).

As has been described above, the robot apparatus 1 has two operation modes, i.e. “not-at-home mode” and “at-home mode”, in which different monitoring operations are executed. Thus, only by executing switching between these modes, can the robot apparatus 1 be caused to execute monitoring operations that are suited to a static environment where the user is not at home and a dynamic environment where the user is at home.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A robot apparatus for executing a monitoring operation, comprising:
an operation mode switching unit that switches an operation mode of the robot apparatus between a first operation mode and a second operation mode; and
a control unit that controls the operation of the robot apparatus, causes the robot apparatus to execute a first monitoring operation in the first operation mode, which is corresponded to a dynamic environment where a user is at home, and causes the robot apparatus to execute a second monitoring operation in the second operation mode, which is corresponded to a static environment where the user is not at home.

2. The robot apparatus according to claim 1, wherein the second monitoring operation has a higher security level than the first monitoring operation.

3. The robot apparatus according to claim 1, further comprising a movement mechanism that moves a main body of the robot apparatus,
wherein the second monitoring operation includes an operation in which the robot apparatus patrols an inside of a house by using of the movement mechanism.

4. The robot apparatus according to claim 1, further comprising a voice recognition unit that executes a voice recognition process for recognizing a voice of the user,
wherein the operation mode switching unit is configured to switch the operation mode between the first operation mode and the second operation mode in accordance with the voice of the user that is recognized by the voice recognition unit.

5. The robot apparatus according to claim 1, wherein the second monitoring operation includes an operation in which the robot apparatus recognizes the face of a person who is present in a house and thereby determines whether the person is the user, and an operation in which the robot apparatus issues information, when it is determined that the person is not the user, to an outside about the presence of the person in the house.

6. The robot apparatus according to claim 1, wherein the robot apparatus further includes a third operation mode,
the operation mode switching unit includes a unit that switches the operation mode of the robot apparatus to the third operation mode, and
the control unit is configured to cause the robot apparatus to execute in the third operation mode an operation for informing the user of check items for safety confirmation by the user.

7. The robot apparatus according to claim 1, further comprising:
a communication device that executes wireless communication;
a movement mechanism that moves, when a remote-control command from an external terminal is received by the communication device, a main body of the robot apparatus to a location that is designated by the remote-control command;
a camera unit that images the designated location; and
a video data transmission unit that transmits video data, which is acquired by the camera unit, to the external terminal by communication between the communication device and the external terminal.

8. A robot apparatus for executing a monitoring operation, comprising:
a main body including an auto-movement mechanism;
a sensor that is provided on the main body and detects occurrence of abnormality in a house;
an operation mode selection unit that selects one of an at-home mode corresponding to a case where a user is at home and a not-at-home mode corresponding to a case where the user is not at home; and
a monitoring operation execution unit that executes, when the at-home mode is selected, a monitoring operation using the movement mechanism and the sensor at a first security level, and executes, when the not-at-home mode is selected, a monitoring operation using the movement mechanism and the sensor at a second security level that is higher than the first security level.

9. The robot apparatus according to claim 8, wherein the operation mode selection unit includes a voice recognition unit that executes a voice recognition process for recognizing a voice of the user, and a unit that selects one of the at-home mode and the not-at-home mode in accordance with the voice of the user that is recognized by the voice recognition unit.

10. The robot apparatus according to claim 8, further comprising a communication device that executes wireless communication,
wherein the monitoring operation execution unit includes a unit that recognizes the face of a person who is present in the house and thereby determines whether the person is the user or a person other than the user, and a unit that issues information, when it is determined, while the not-at-home mode is selected, that the person is a person other than the user, to an outside about the presence of the person in the house.

11. A robot apparatus for executing a monitoring operation, comprising:
means for switching an operation mode of the robot apparatus between a first operation mode and a second operation mode; and
means for controlling the operation of the robot apparatus to execute a first monitoring operation in the first operation mode, which is corresponded to a dynamic environment where a user is at home, and execute a second monitoring operation in the second operation mode, which is corresponded to a static environment where the user is not at home.

12. The robot apparatus according to claim 11, wherein the second monitoring operation has a higher security level than the first monitoring operation.

13. The robot apparatus according to claim 11, further comprising a movement mechanism that moves a main body of the robot apparatus,
wherein the second monitoring operation includes an operation in which the robot apparatus patrols an inside of a house by using of the movement mechanism.

14. The robot apparatus according to claim 11, further comprising means for executing a voice recognition process for recognizing a voice of the user,
wherein the means for switching includes means for switching the operation mode between the first operation mode and the second operation mode in accordance with the voice of the user that is recognized by the voice recognition process.

15. The robot apparatus according to claim 11, wherein the second monitoring operation includes an operation in which the robot apparatus recognizes the face of a person who is present in a house and thereby determines whether the person is the user, and an operation in which the robot apparatus issues information, when it is determined that the person is not the user, to an outside about the presence of the person in the house.
